(19) United States
(12) Patent Application Publication
(10) Pub. No.: US 2019/0056765 A1
(43) Pub. Date: Feb. 21, 2019

(54) Electronic Scheduling Assembly

(71) Applicants: Deonna Harris, Hampton, VA (US); Orlando Harris, Hampton, VA (US)

(72) Inventors: Deonna Harris, Hampton, VA (US); Orlando Harris, Hampton, VA (US)

(21) Appl. No.: 15/678,178

(22) Filed: Aug. 16, 2017

(51) Int. Cl. G06F 1/16; G06F 3/0354; G06F 3/0488; G06F 3/0482; G06F 3/16; G06Q 10/10

(52) U.S. Cl. CPC G06F 1/1643; G06F 1/1626; G06F 1/1684; G06F 1/1698; G06F 1/1635; G06Q 10/109; G06F 3/03545; G06F 3/04886; G06F 3/0482; G06F 3/167; G06F 1/1688

(57) ABSTRACT

A electronic scheduling assembly includes a housing that may be suspended on a vertical support surface thereby facilitating the housing to be accessible to a user. A processor is positioned within the housing and an electronic memory is positioned within the housing. A touch screen is coupled to the front wall of the housing and the touch screen is selectively manipulated. The touch screen displays indicia relating to data stored in the electronic memory. A stylus is configured to be manipulated. The stylus engages the touch screen to control operational parameters of the processor and to manipulate the indicia on the touch screen.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to scheduling devices and more particularly pertains to a new scheduling device for electronically tracking a schedule and a budget.

### BRIEF SUMMARY OF THE INVENTION

An embodiment of the disclosure meets the needs presented above by generally comprising a housing that may be suspended on a vertical support surface thereby facilitating the housing to be accessible to a user. A processor is positioned within the housing and an electronic memory is positioned within the housing. A touch screen is coupled to the front wall of the housing and the touch screen is selectively manipulated. The touch screen displays indicia relating to data stored in the electronic memory. A stylus is configured to be manipulated. The stylus engages the touch screen to control operational parameters of the processor and to manipulate the indicia on the touch screen.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a electronic scheduling assembly according to an embodiment of the disclosure.

FIG. 2 is a perspective in-use view of an embodiment of the disclosure.

FIG. 3 is a schematic view of an embodiment of the disclosure.

### DETAILED DESCRIPTION OF THE INVENTION

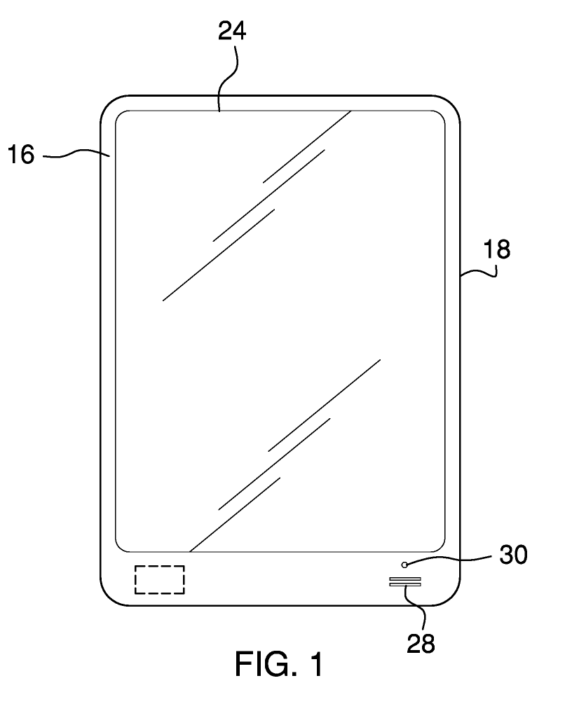

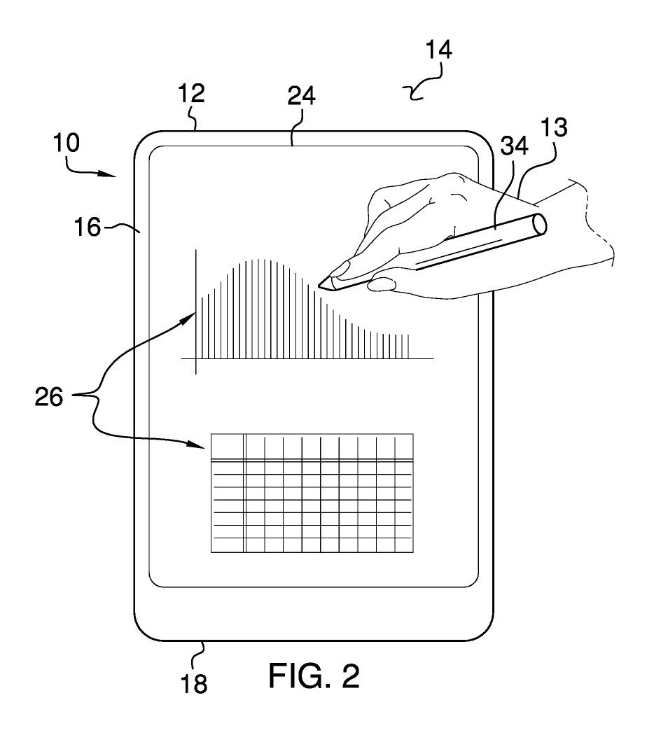

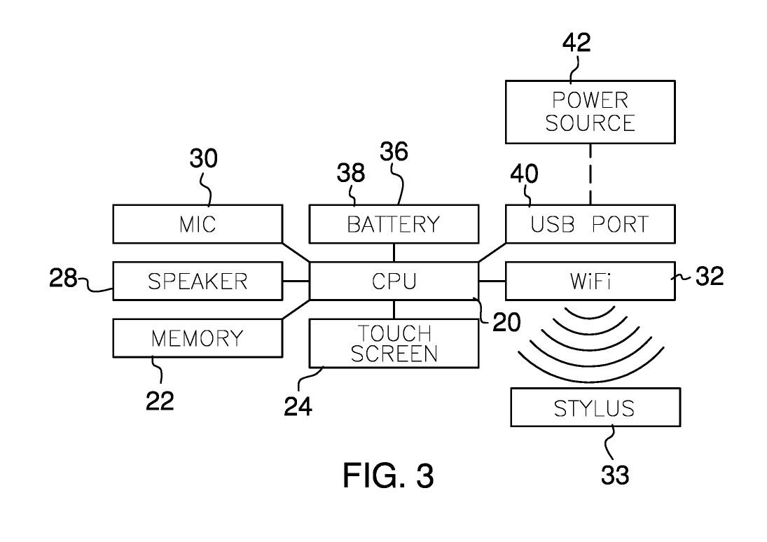

With reference now to the drawings, and in particular to FIGS. 1 through 3 thereof, a new scheduling device embodying the principles and concepts of an embodiment of the disclosure and generally designated by the reference numeral 10 will be described.

As best illustrated in FIGS. 1 through 3, the electronic scheduling assembly 10 generally comprises a housing 12 that is suspended on a vertical support surface 14 thereby facilitating the housing 12 to be accessible to a user 13. The housing 12 may be suspended from the vertical support surface 14 via a plurality of screws, adhesive strips or any other conventional mechanical means of resiliently suspending an object on a vertical support surface 14. Moreover, the vertical support surface 14 may be a wall in a building such as a house or a business. The housing 12 has a front side 16 and a back side 18 and the back side 18 is removably coupled to the vertical support surface 14.

A processor 20 is provided and the processor 20 is positioned within the housing 12. The processor 20 may be an electronic processor or the like. An electronic memory 22 is provided and the electronic memory 22 is positioned within the housing 12. The electronic memory 22 is electrically coupled to the processor 20 and the electronic memory 22 stores data pertaining to operational parameters of the processor 20. Moreover, the electronic memory 22 stores data pertaining to a plurality of menus, widgets and voice commands. The electronic memory 22 may be ram memory, a hard disk drive or any other conventional electronic memory for storing digital data.

A touch screen 24 is coupled to the front wall of the housing 12 and the touch screen 24 is selectively manipulated. The touch screen 24 is electrically coupled to the processor 20 and the touch screen 24 displays indicia 26 related to the menus and widgets stored in the electronic memory 22. The touch screen 24 may selectively display a home screen and each of the widgets may be displayed on the home screen. Moreover, the touch screen 24 may be an LCD touch screen or the like.

Each of the widgets displayed on the home screen is associated with a corresponding one of the menus stored in the electronic memory 22. The corresponding menu is displayed on the touch screen 24 when the associated widget is selected. Moreover, each of the corresponding menus is customizable with respect to an appearance corresponding to each of the menus and data that is displayed on each of the menus. The plurality of menus may include a customizable to do list, a budget menu that includes paid and unpaid bills, a task menu that includes children's chores, a map menu that includes a world map, a white board menu, a chalk board menu, a weather menu and a sticky note menu.

A speaker 28 is coupled to the housing 12 to emit audible sounds outwardly therefrom and the speaker 28 is electrically coupled to the processor 20. A microphone 30 is coupled to the housing 12 to detect spoken commands. The microphone 30 is electrically coupled to the processor 20 such that the microphone 30 controls selected operational parameters of the processor 20. In this way the processor 20 responds to spoken verbal commands thereby facilitating the touch screen 24 to react to the spoken verbal commands with respect to indicia 26 that the touch screen 24 displays.

A transceiver 32 is provided and the transceiver 32 is positioned within the housing 12. The transceiver 32 is electrically coupled to the processor 20 and the transceiver 32 is in electrical communication with an extrinsic communication network 33. The extrinsic communication network 33 may be the internet or the like and the transceiver 32 may be a radio frequency transceiver 32. Additionally, the transceiver 32 may employ a WPAN signal and the transceiver 32 may import and export data with respect to the electronic memory 22. The imported and exported data may be checking account transactions that are incorporated into the budget menu.

A stylus 34 is provided and the stylus 34 may be manipulated. The stylus 34 engages the touch screen 24 to select one of the widgets on the touch screen 24. In this way the plurality of menus is navigated. Additionally, the stylus 34 facilitates each of the menus to be selectively customized with respect to writing being imported into and displayed on each of the menus.

A power supply 36 is positioned within the housing 12. The power supply 36 is electrically coupled to the processor 20 and the power supply 36 comprises at least one battery 38. An input port 40 is coupled to the housing 12 and the input port 40 is electrically coupled to the processor 20. Moreover, the input port 40 is selectively electrically coupled to a power source 42 for charging the at least one battery 38. The power source 42 may be an external battery charger or the like and the input port 40 may be a usb port or the like.

In use, the housing 12 is coupled to the vertical support surface 14 such that the housing 12 is accessible to the user 13. The user 13 manipulates the stylus 34 to select widgets and navigate the plurality of menus. Additionally, the user 13 manipulates the stylus 34 to electronically write on the plurality of menus to make notes or to customize the appearance corresponding to each of the menus. The budget menu tracks spending and income to facilitate budget tracking on a weekly, monthly and yearly basis. The stylus 34 is manipulated to customize the to do list with respect to entering tasks to be completed and defining selected tasks as being complete. In this way a complex list of tasks is tracked with respect to being completed over a selected duration of time. The stylus 34 is manipulated to write selected notes on the sticky note menu. Moreover, the notes written on the sticky note menu are continuously displayed on the touch screen 24 until such time that the notes are manually removed by the user 13.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electronic scheduling assembly being configured to track a selected schedule, a budget and other sets of data, said assembly comprising:
a housing being configured to be suspended on a vertical support surface thereby facilitating said housing to be accessible to a user;
a processor being positioned within said housing;
an electronic memory being positioned within said housing;
a touch screen being coupled to said front wall of said housing wherein said touch screen is configured to be manipulated, said touch screen displaying indicia relating to data stored in said electronic memory; and
a stylus being configured to be manipulated, said stylus engaging said touch screen to control operational parameters of said processor and to manipulate said indicia on said touch screen.

2. The assembly according to claim 1, wherein said electronic memory is electrically coupled to said processor, said electronic memory storing data pertaining to operational parameters of said processor, a plurality of menus, widgets and voice commands.

3. The assembly according to claim 2, wherein said touch screen is electrically coupled to said processor, said touch screen displaying indicia related to the menus and widgets stored in said electronic memory.

4. The assembly according to claim 1, further comprising a speaker being coupled to said housing wherein said speaker is configured to emit audible sounds outwardly therefrom, said speaker being electrically coupled to said processor.

5. The assembly according to claim 1, further comprising a microphone being coupled to said housing wherein said microphone is configured to detect spoken commands, said microphone being electrically coupled to said processor such that said microphone controls selected operational parameters of said processor.

6. The assembly according to claim 1, further comprising a transceiver being positioned within said housing, said transceiver being electrically coupled to said processor, said transceiver being configured to be in electrical communication with an extrinsic communication network.

7. The assembly according to claim 1, further comprising a power supply being positioned within said housing, said power supply being electrically coupled to said processor, said power supply comprising at least one battery.

8. An electronic scheduling assembly being configured to track a selected schedule, a budget and other sets of data, said assembly comprising:
a housing being configured to be suspended on a vertical support surface thereby facilitating said housing to be accessible to a user, said housing having a front side and a back side, said back side being configured to be removably coupled to the vertical support surface;
a processor being positioned within said housing;
an electronic memory being positioned within said housing, said electronic memory being electrically coupled to said processor, said electronic memory storing data pertaining to operational parameters of said processor, a plurality of menus, widgets and voice commands;
a touch screen being coupled to said front wall of said housing wherein said touch screen is configured to be manipulated, said touch screen being electrically coupled to said processor, said touch screen displaying indicia related to the menus and widgets stored in said electronic memory;
a speaker being coupled to said housing wherein said speaker is configured to emit audible sounds outwardly therefrom, said speaker being electrically coupled to said processor;
a microphone being coupled to said housing wherein said microphone is configured to detect spoken commands, said microphone being electrically coupled to said processor such that said microphone controls selected operational parameters of said processor;
a transceiver being positioned within said housing, said transceiver being electrically coupled to said processor, said transceiver being configured to be in electrical communication with an extrinsic communication network;
a stylus being configured to be manipulated, said stylus engaging said touch screen to select one of said widgets on said touch screen thereby facilitating said plurality of menus to be navigated; and
a power supply being positioned within said housing, said power supply being electrically coupled to said processor, said power supply comprising at least one battery.
